(19) United States
(12) Patent Application Publication
(10) Pub. No.: US 2024/0396415 A1
(43) Pub. Date: Nov. 28, 2024

(54) Rotational Linear Motor

(71) Applicant: Daniel Patrick Jones, Pinellas Park, FL (US)

(72) Inventor: Daniel Patrick Jones, Pinellas Park, FL (US)

(21) Appl. No.: 18/324,294

(22) Filed: May 26, 2023

(51) Int. Cl. H02K 19/02; H02K 1/14

(52) U.S. Cl. CPC H02K 19/02; H02K 1/145

(57) ABSTRACT

The invention relates to a rotational linear motor drive system for the acceleration of a rotational shaft. The rotational linear motor drive system comprises a stator, with at least two stator elements, arranged on either side of a non-magnetic conductive rotor. Each stator maybe connected to its own energy source or may be connected in series to a single energy source. The rotor can operate at the same time with the two synchronized stator groups, or the rotor may be driven out of phase by each stator group. No permanent magnets are used in the design of the motor.

### FIELD OF CLASSIFICATION SEARCH

B60L13/03, B65G54/02, H02P6/16, H02K41/031

References Cited
U.S. PATENT DOCUMENTS

| 10,862,385B2 | Dec. 8, 2020 | Julen et al. | B60L13/03 |
|---|---|---|---|
| 9,617,089 | Apr. 11, 2017 | Josefowitz et al. | B65G54/02 |

FOREIGN PATENT DOCUMENTS

| | | | |
|---|---|---|---|
| EP3376166B1 | Aug. 13, 2018 | Veröffentlichungstag | H02P6/16 |
| JP6584619B2 | Oct. 4, 2018 | Hitachi Ltd | H02K41/031 |

### TECHNICAL FIELD

The invention is a rotational linear motor drive system using a linear stator group arranged in a circular configuration on either side of a non-magnetic conductive rotor. Each stator group with windings are arranged in a circular configuration, and for three phase electrical operation on either side of the rotor. The invention also relates to the frequency driven speed to control the rotor rotation, with synchronized stator drives or out of phase stator drives.

### STATE OF THE ART

Linear engine drives are well known in the state of the art. An example is a high-speed passenger train or individual transport of single items in manufacturing lines. All use linear motors to move items in translational movement. This common feature can be overcome with a unique configuration on the stator design to allow complete circular movement of a non-magnetic conductive rotor.

### BRIEF DESCRIPTION OF THE DRAWINGS

For a more complete understanding of this disclosure and features, reference is made to the following description, along with the related drawings, in which:

FIGS. 1 and 1a illustrate an example rotational linear motor in accordance with this disclosure;

FIG. 2 illustrates an example construction of this disclosure;

FIG. 3 illustrates how, as an example, stator cores can be arranged in a circular configuration;

FIG. 4 illustrates an example placement of the windings on the stator cores;

### DESCRIPTION OF INVENTION

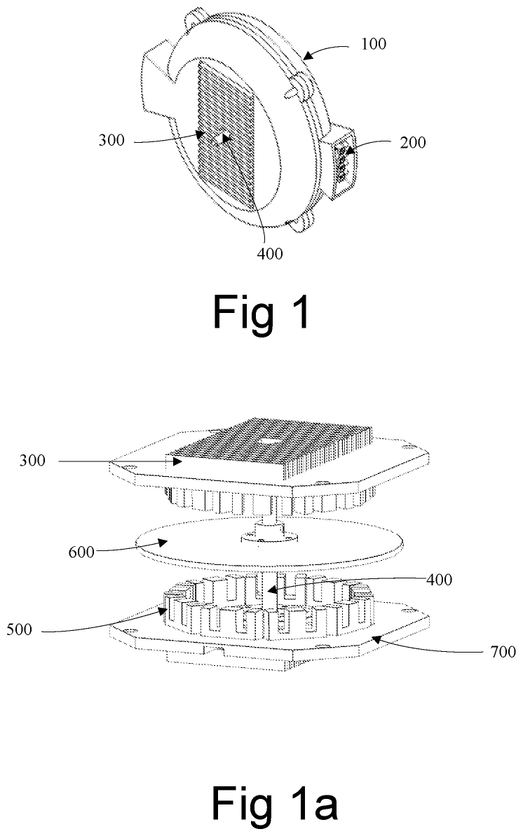

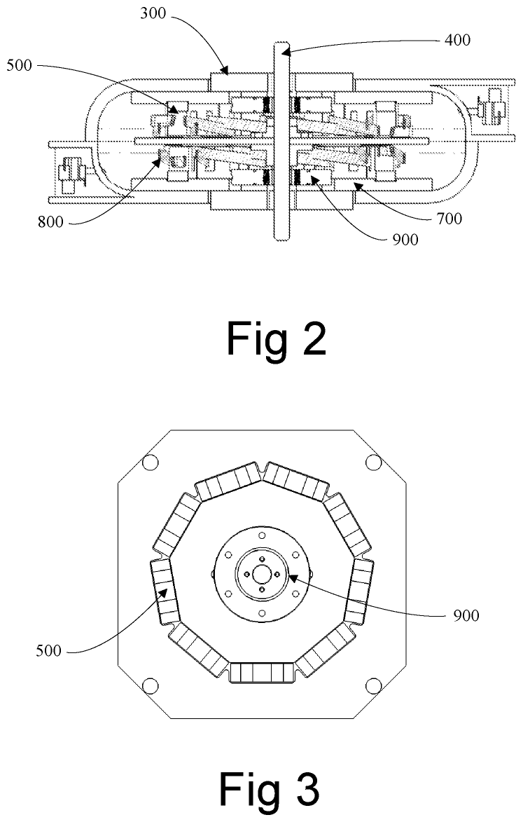

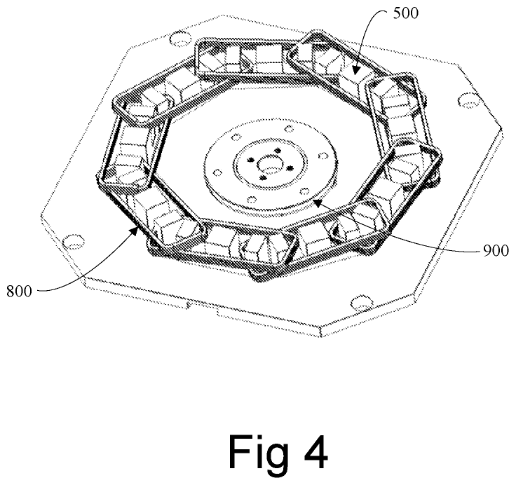

FIGS. 1 through 4, described below, and the various representations used to describe the principles of the present invention in this document are by way of illustration only, and should not be construed in any way to limit the scope of the invention. Those skilled in the art will understand that the principles of the present invention may be implemented in any type of suitable arranged device or system.

The invention relates to a rotational linear motor drive system as a linear stator group arranged in a circular configuration on either side of a non-magnetic conductive rotor. Having two stator groups, both torque and speed are increased proportional to input voltage. Speed may be increased by advancing the frequency of the input waveform. The magnetic field produced by the stator windings will create an opposite corresponding current and associated magnetic field in the non-magnetic conductive rotor, causing it to spin. The induced current will produce a magnetic field opposing the change in magnetic flux in the stator windings. Three phase electrical input wave form will allow the changing induced current in the non-magnetic conductive rotor to produce the rotational spin of the rotor.

This disclosure provides a configuration for a stator that may be used to drive a rotor attached to a shaft to function as a motor producing rotational movement of the shaft without the use of permanent magnets. As described in more detail below, the non-magnetic conductive rotor will have an induced current such that the induced current always tends to oppose the cause which produced it, hence the associated magnetic field will be in opposition with the stator generated field producing motion of the rotor by repulsive force of like poles.

### Description of Preferred Embodiment

FIG. 1 illustrates an exemplary embodiment of a rotational linear motor according to the present invention in a three-dimensional isometric view. The rotational liner motor 100 consists of a housing enclosing two stator elements, a non-magnetic conductive rotor, 400 shaft, 200 electrical connections and 300 integral heat sink.

### SUMMARY

This disclosure provides a circular configuration of stators windings that produces a rotational linear motor. This embodiment provides for heat removal by use of an integral heat sink on opposite sides of the stator windings. In a first embodiment, the rotor is driven by synchronized stator fields on either side of a non-magnetic conductive rotor. In the second embodiment, the rotor is driven by out of phase stator fields from either side of the rotor. In both embodiments, the speed of the motor is driven by the input frequency of the three phase current. In the third embodiment, the rotor may be driven by a single stator on one side of the rotor. The current embodiment uses three phase current at varying frequency to produce rotational movement of the rotor, but other phasing and waveforms will work as well. No permanent magnets are used in the design of any embodiment.

What is claimed:

1. Rotational linear motor drive system for the acceleration of a rotational shaft using induced currents in a non-magnetic conductive rotor.

2. Speed control of the motor by varying the input current frequency.

3. Circular configured stator coils either placed above, below, or both sides of the rotor.

4. Design for a motor that can produce rotational shaft movement without use of permanent magnets.

5. Integral heat sink on stator plate.
